(19) United States
(12) Patent Application Publication
(10) Pub. No.: US 2012/0216191 A1
(43) Pub. Date: Aug. 23, 2012

(54) CONFIGURING UNIVERSAL SERIAL BUS DEVICE IN VIRTUAL ENVIRONMENT

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/232,136

(22) Filed: Sep. 14, 2011

(30) Foreign Application Priority Data
Feb. 18, 2011 (TW) 100105545

(51) Int. Cl. G06F 9/455

(52) U.S. Cl. 718/1

(57) ABSTRACT

In a computer system, virtual machine (VM) guests are concurrently instantiated on a VM host. When a USB device is plugged in to the computer system, the VM host loads a backend driver associated with the USB device, which controls the USB device. The VM host provides a user interface to presenting a list of VM guests, in which a user can select a VM guest to be bound with the USB device. Then the VM host allocates the control of the USB device to the selected VM guest.

### BACKGROUND

1. Technical Field

The disclosure generally relates to a method and a system for configuring a universal serial bus (USB) device in a virtual environment.

2. Description of Related Art

Virtualization is a technique in which a computer system is partitioned into multiple isolated virtual machines (VMs), each of which appears to the software within it to be a complete computer system. A typical virtual system can operate multiple VM guests by installing a VM host with a host operating system (OS) for operating the VM guests. Each VM guest may include a guest OS, which may be unaware of any of the other VM guests event though they are instantiated on the same computer system. The VM host is responsible for providing the environment in which each VM guest runs and maintaining isolation between the VM guests.

Each VM guest may have access to a set of physical devices, such as USB devices. The VM host controls which physical devices are assigned to each VM guest, and also implements the devices that are visible to VM guests. If a physical device is exclusively assigned to a single VM guest, it is not available to the other VM guests. In current practice, when a physical device is attached to the computer system, the VM host typically assigns the physical device to a predetermined VM guest according to configuration settings. It is inconvenient for the user to switch the control of the physical device from the predetermined VM guest to another desired VM guest. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a computer system in which virtual machines are configured.

FIG. 2 illustrates a schematic diagram of one embodiment of the computer system, to which a USB device is plugged.

FIG. 3 illustrates a view of one embodiment of a graphic user interface for selecting a target VM guest from a VM guest list.

FIG. 4 illustrates a schematic diagram of one embodiment of the computer system, in which the USB device is assigned to the target VM guest.

FIG. 5 illustrates a schematic diagram of one embodiment of the computer system, in which the USB device is unplugged.

FIG. 6 illustrates a schematic diagram of one embodiment of the computer system, in which two USB devices are attached.

FIG. 7 illustrates a view of one embodiment of a graphic user interface for selecting a target USB device from a USB device list.

FIG. 8 illustrates a view of one embodiment of a graphic user interface for selecting a target VM guest from a VM guest list.

FIG. 9 illustrates a schematic diagram of one embodiment of the computer system, in which the target USB device is assigned to the target VM guest.

FIG. 10 is an operational flow diagram representing an embodiment of a method of assigning a new plugged USB device to a target VM guest in the computer system of FIG. 1.

FIG. 11 is an operational flow diagram representing an embodiment of a method of taking back control of the USB device when the USB device is unplugged from the computer system of FIG. 1.

FIG. 12 is an operational flow diagram representing an embodiment of a method of selecting a target USB device and assigning the target USB device to a target VM guest in the computer system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

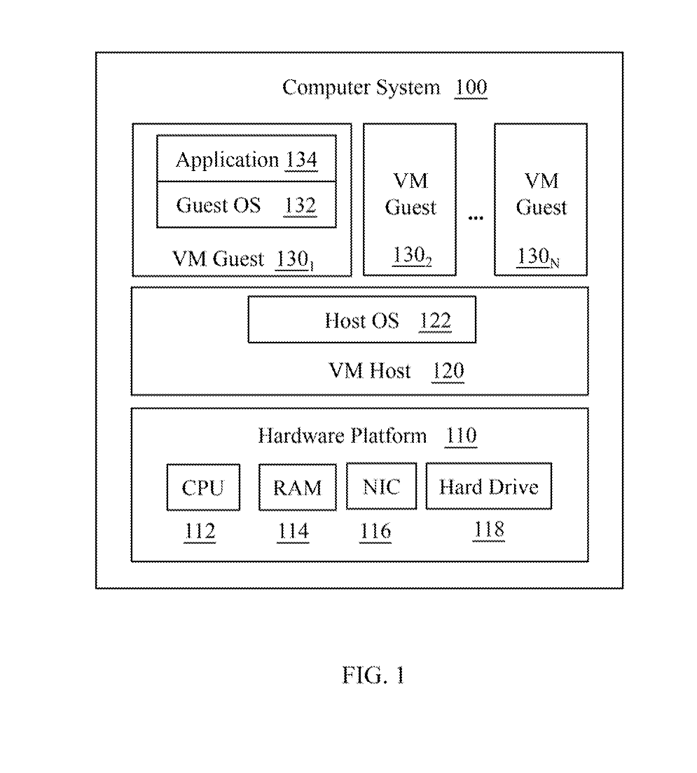

FIG. 1 depicts a block diagram of virtual machines configured on a computer system 100. The computer system 100 may be constructed on a desktop, a laptop, or on a server grade hardware platform 110 such as an x86 architecture platform. Such a hardware platform may include a central processing unit (CPU) 112, a random access memory (RAM) 114, a network interface controller (NIC) 116 (also referred to herein as a network card), a hard drive 118 and other I/O devices such as a mouse and a keyboard (not shown in FIG. 1).

The computer system 100 can operate one or more virtual machine (VM) guests 130₁, 130₂ . . . 130_{N}, collectively designated by a reference numeral 130, by installing a VM host 120 with a host operating system (OS) 122 for operating the VM guests 130. Each of the VM guests 130 may include a guest OS and one or more software applications. For example, the VM guest 130₁ may include a guest OS 132 and an application 134 that is installed and executable in the VM guest 130₁.

The VM host 120 may control the hardware platform 110, present to the VM guest 130 virtualized hardware resources, and manage the VM guests 130. Multiple instances of the VM guests 130 may share the virtualized hardware resources and each of them may execute programs as if it was a physical machine. Each of the VM guests 130 may have access to a set of physical devices. The VM host 120 may control which physical devices are assigned to each of the VM guests 130, and also implements the devices that are visible to the VM guests 130. If a physical device is exclusively assigned to a single VM guest, it is not available to the other VM guests.

The computer system 100 may assign a unique Internet protocol (IP) address for each of the VM guests 130 manually or automatically. The computer system 100 may create an Address Resolution Protocol (ARP) table that stores and maintains IP addresses of the VM guests 130. The ARP table may further store a VM ID or an MAC address to mark a unique IP address for each VM guest. The VM ID is an identification key to identify a unique VM guest. The VM host 120 assigns the MAC address when the corresponding VM guest is created. Each of the VM guests 130 has a unique MAC address, which can be recognized in a local area network (LAN) or a wide area network (WAN) such as the Internet. The IP address of a VM guest can be acquired from the ARP table according to either the VM ID or the MAC address of the VM guest.

The VM host 120 may establish a connection channel based on transmission control protocol (TCP) between the VM host 120 and each of the VM guests 30. For example, when a connection channel is established between the VM host 120 and the VM guest 130₁, the VM host 120 and the VM guest 130₁ can communicate with each other.

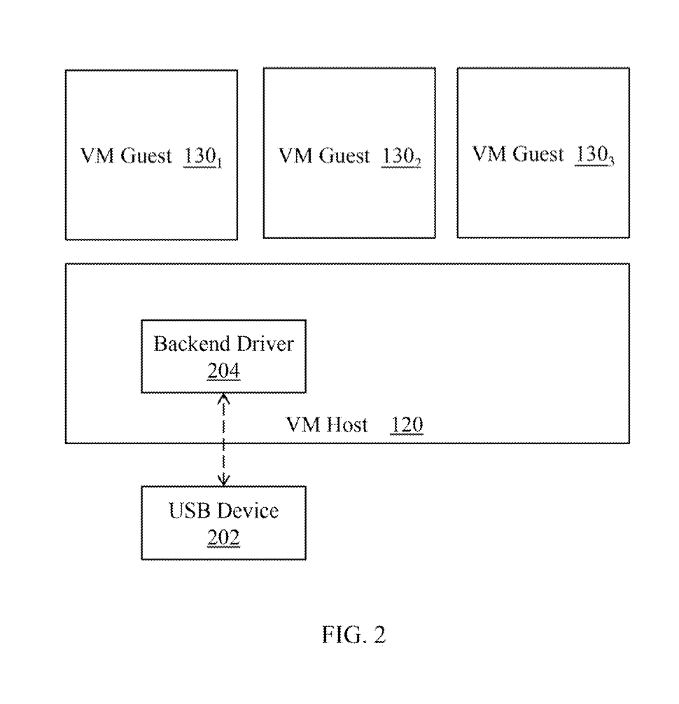

In FIG. 2, the VM guest 130₁, 130₂ and 130₃ are instantiated on the VM host 120. When a USB device 202 is plugged into the computer system 100, the VM host 120 may obtain device information of the USB device 202 and determine a backend driver 204 associated with the USB device 202 according to the device information. The device information may include a vender ID and a device ID of the USB device 202. Thus the VM host 120 may load the backend driver 204. The backend driver 204 is software controlling the USB device 202 to run in the VM host 120. The backend driver 204 can directly control the USB device 202.

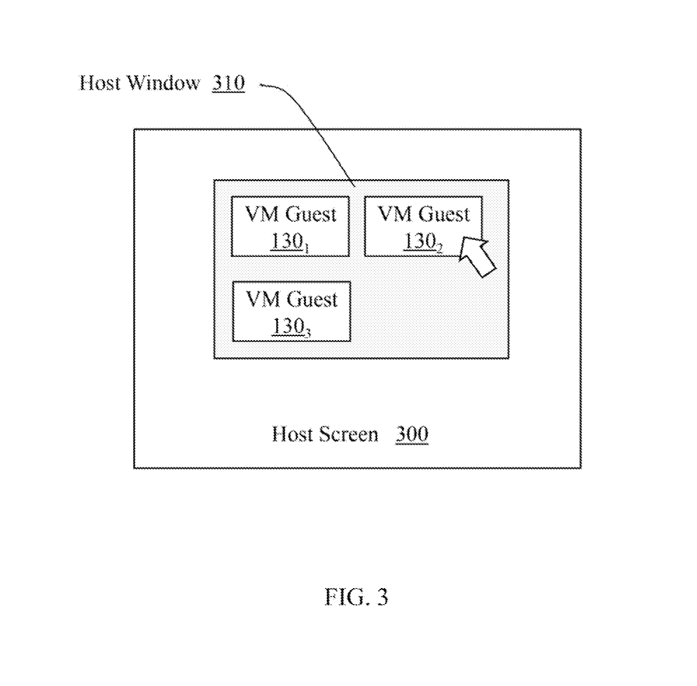

In FIG. 3, the VM host 120 may display a host window 310 in a host screen 300. The host window 310 may provide a user interface presenting a list of VM guests, which are concurrently instantiated on the VM host 120. In FIG. 3, the list includes the VM guest 130₁, 130₂ and 130₃. A user may select one of them to be assigned with the USB device 202. For example, the user selects the VM guest 130₂.

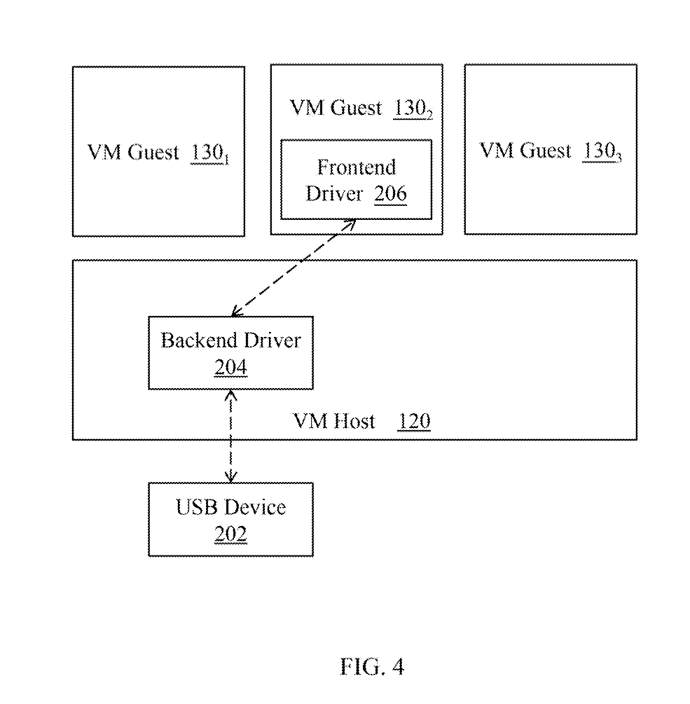

In FIG. 4, when the VM guest 130₂ is selected as a target VM guest, the VM host 120 may transmit the device information of the USB device 202 to the VM guest 130₂. The VM guest 130₂ may determine a frontend driver 206 associated with the USB device 202 according to the device information. Thus the VM guest 130₂ may load the frontend driver 206. The frontend driver 206 is software controlling the USB device 202 to run in the VM guest 130₂. The backend driver 204 may provide an abstracted interface for the frontend driver 206 of the VM guest 130₂. The frontend driver 206 may communicate with the backend driver 204 to indirectly control the USB device 202 via the backend driver 204. When the VM guest 130₂ is selected as a target VM guest, the VM host 120 may establish a communication connection between the backend driver 204 and the frontend driver 206 of the VM guest 130₂ and allocate the control of the USB device 202 to the VM guest 130₂ via the communication connection.

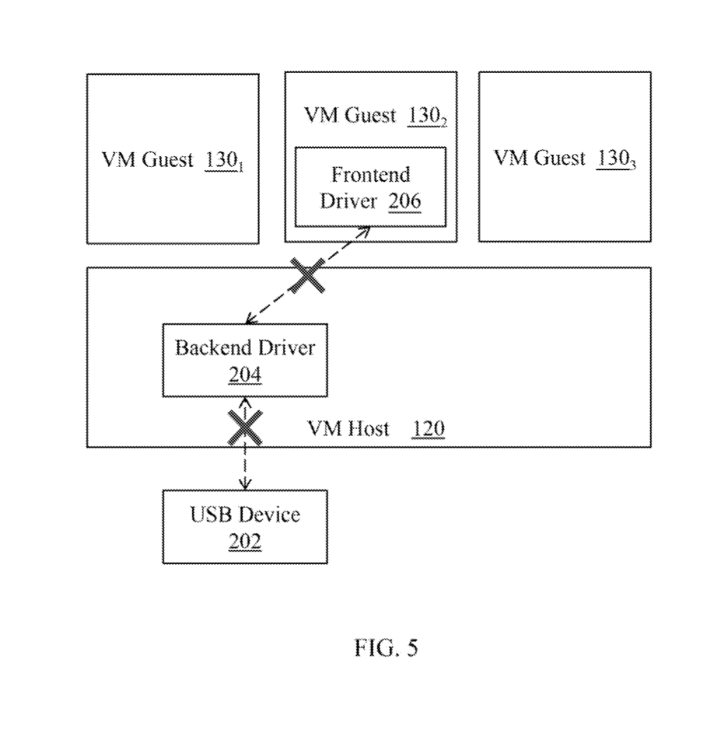

In FIG. 5, when the USB device 202 is unplugged from the computer system 100, the backend driver 204 will be disconnected to the USB device 202. The VM host 120 may destroy the communication connection between the backend driver 204 and the frontend driver 206 of the VM guest 130₂. In some embodiments, when the USB device 202 is unplugged from the computer system 100, the VM host 120 may unload the backend driver 204 and the VM guest 130₂ may unload the frontend driver 206.

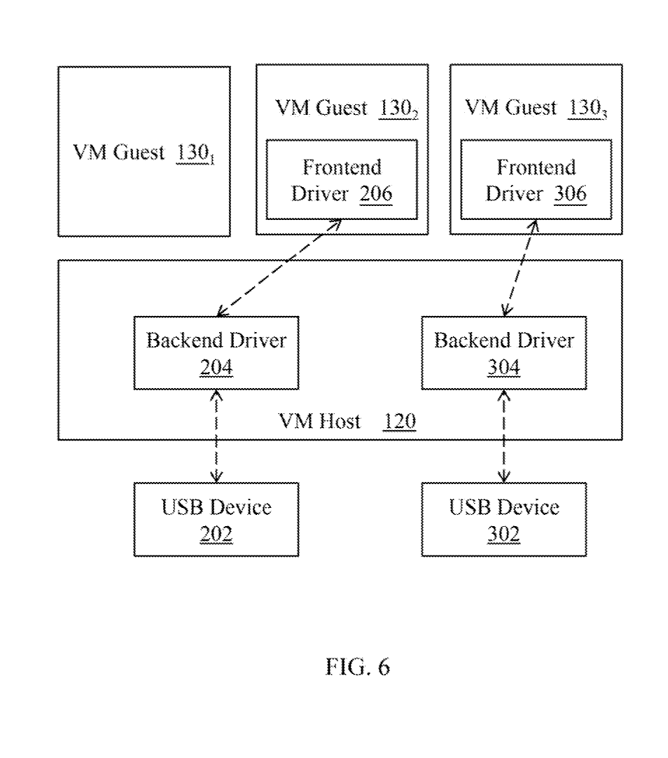

In FIG. 6, the VM guest 130₁, 130₂ and 130₃ are instantiated on the VM host 120 and the USB device 202 and the USB device 302 are attached to the computer system 100. The USB device 202 is assigned to the VM guest 130₂ via a communication connection between the backend driver 204 and the frontend driver 206 of the VM guest 130₂. The USB device 302 is assigned to the VM guest 130₃ via a communication connection between the backend driver 304 and the frontend driver 306 of the VM guest 130₃.

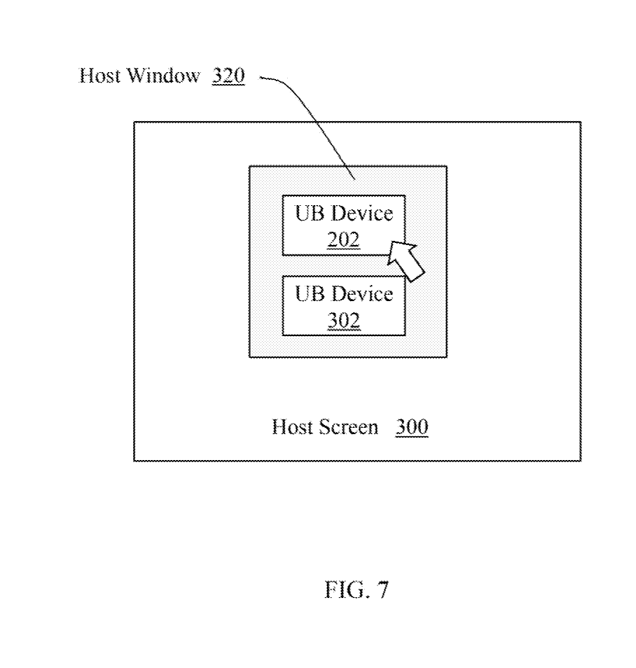

When the user wants to reassign one of the USB devices to one of the VM guests as shown in FIG. 6, the VM host 120 may display a host window 320 presenting a list of available USB devices in the host screen 300 of the VM host 120. In FIG. 7, an example of a user interface of the host window 320 is illustrated. The list includes the USB device 202 and 302. The user may select a target USB device from the list, which is desired to be reassigned. For example, the user selects the USB device 202.

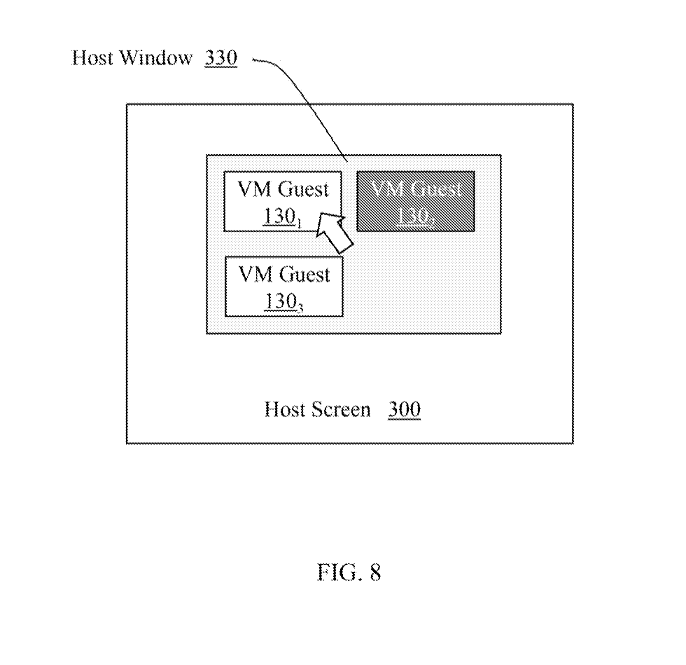

When the USB device 202 is selected as a target USB device, the VM host 120 may display a host window 330 presenting a list of available VM guest in the host screen 300 of the VM host. In FIG. 8, an example of a user interface of the host window 330 is illustrated. The list includes the VM guest 130₁, 130₂ and 130₃. According to FIG. 6, the USB device 202 has been assigned to the VM guest 130₂. The VM host 120 may highlight the selection item of the VM guest 130₂ to inform the user that the VM guest 130₂ has the current control of the USB device 202 in some embodiments. The user may select a target VM guest, to which the user wants the USB device 202 reassigned from the list presented in the host window 330. For example, the user selects the VM guest 130₁.

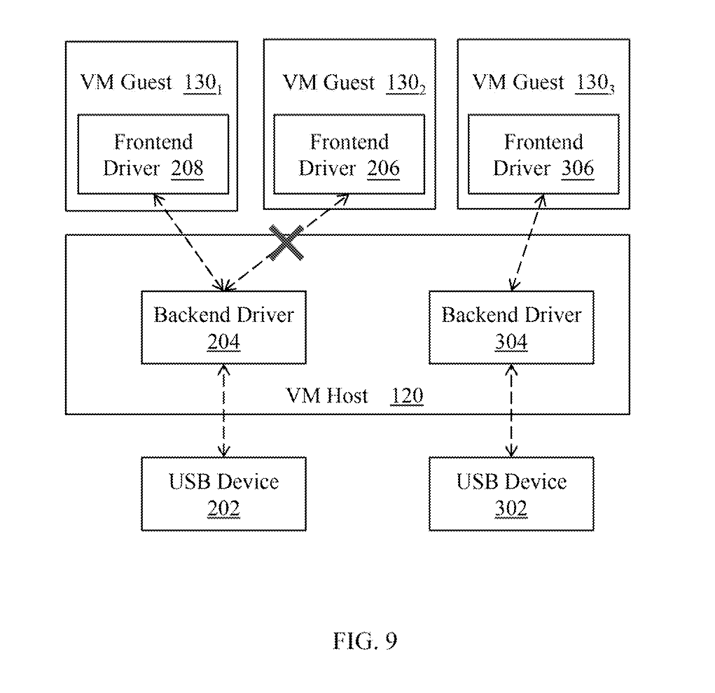

In FIG. 9, when the VM guest 130₁ is selected as a target VM guest, the VM host 120 may destroy the communication connection between the backend driver 204 and the frontend driver 206 of the VM guest 130₂ and transmit the device information of the USB device 202 to the VM guest 130₁. The VM guest 130₁ may determine a frontend driver 208 associated with the USB device 202 according to the device information. Thus the VM guest 130₁ may load the frontend driver 208. The frontend driver 208 is software controlling the USB device 202 to run in the VM guest 130₁. The backend driver 204 may provide an abstract interface for the frontend driver 208 of the VM guest 130₁. The frontend driver 208 may communicate with the backend driver 204 to indirectly control the USB device 202 via the backend driver 204. The VM host 120 may then establish a communication connection between the backend driver 204 and the frontend driver 208 of the VM guest 130₁ and allocate the control of the USB device 202 to the VM guest 130₁ via the communication connection. In some embodiments, when the VM guest 130₂ loses control of the USB device 202, the VM guest 130₂ may unload the frontend driver 206 accordingly.

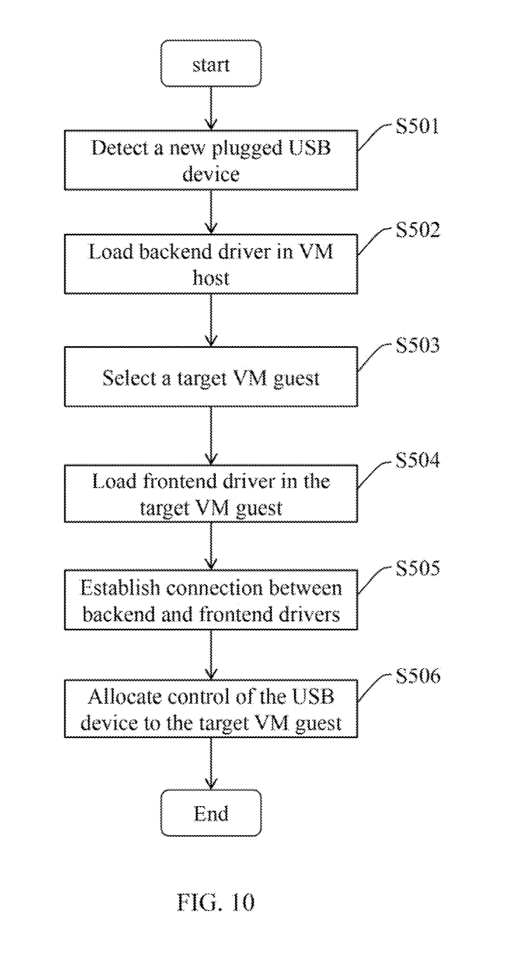

FIG. 10 is a flowchart illustrating one embodiment of a method of assigning a new plugged USB device to a target VM guest in the computer system of FIG. 1. The method may include the following steps.

In step S501, the VM host 120 detects a plug event that the USB device 202 is plugged into the computer system 100.

In step S502, the VM host 120 loads the backend driver 204 associated with the USB device 202 in the VM host 120.

In step S503, the VM host 120 selects the VM guest 130₂ from among the available VM guests according to the user selection from a user interface.

In step S504, the VM guest 130₂ loads the frontend driver 206 associated with the USB device 202 in the VM guest 130₂.

In step S505, the VM host 120 establishes a communication connection between the backend driver 204 and the frontend driver 206 of the VM guest 130₂.

In step S506, the VM host 120 allocates the control of the USB device 202 to the VM guest 130₂ via the communication connection.

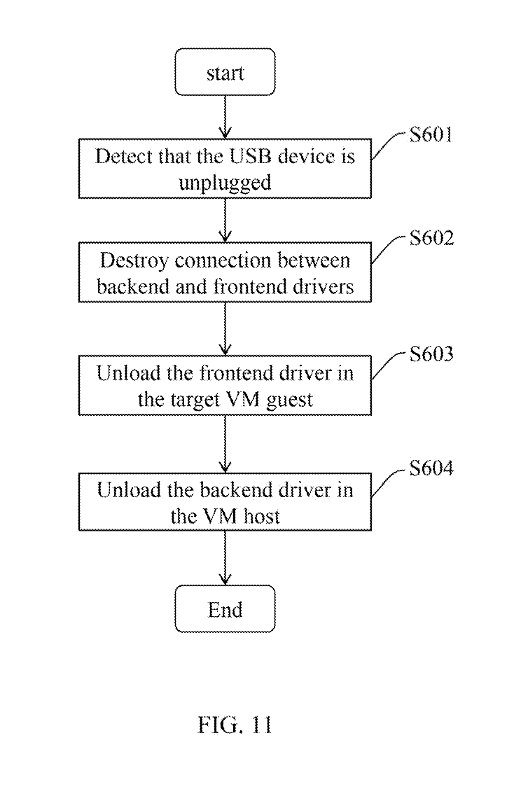

FIG. 11 is a flowchart illustrating one embodiment of a method of taking back control of the USB device when the USB device is unplugged from the computer system of FIG. 1. The method may include the following steps.

In step S601, the VM host 120 detects an unplug event that the USB device 202 is unplugged from the computer system 100.

In step S602, the VM host 120 destroys the communication connection between the backend driver 204 and the frontend driver 206 of the VM guest 130₂.

In step S603, the VM guest 130₂ unloads the frontend driver 206.

In step S604, the VM host 120 unloads the backend driver 204.

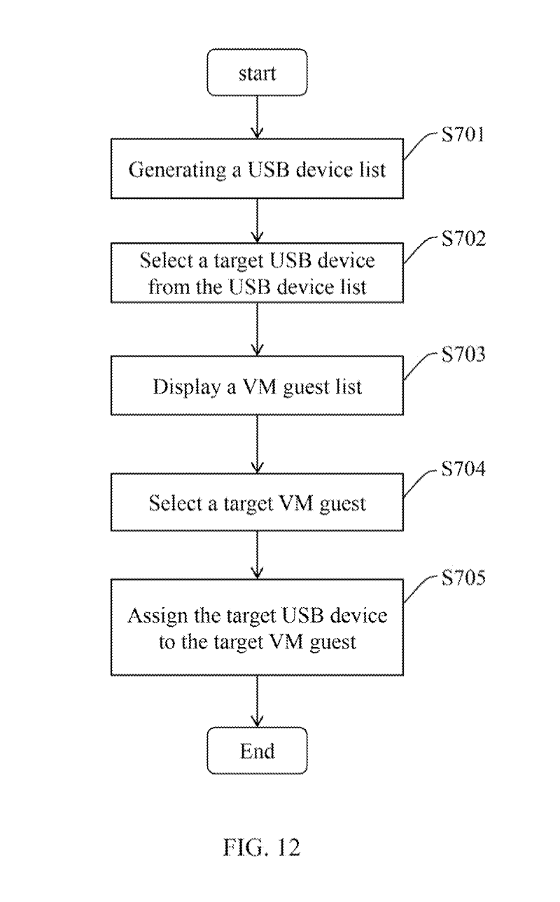

FIG. 12 is a flowchart illustrating one embodiment of a method of selecting a target USB device and assigning the target USB device to a target VM guest in the computer system of FIG. 1. The method may include the following steps.

In step S701, the VM host 120 collects all the USB devices attached to the computer system 100, generates a USB device list and displays the USB device list in a first host window of the VM host 120.

In step S702, the VM host 120 selects a target USB device from the USB device list according to the user selection from the first host window.

In step S703, the VM host 120 displays a VM guest list in a second host window of the VM host 120.

In step S704, the VM host 120 selects a target VM guest from the VM guest list according to the user selection from the second host window.

In step S705, the VM host 120 assigns the target USB device to the target VM guest.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A method for configuring a universal serial bus (USB) device in a computer system, the computer system having a virtual machine (VM) host and a plurality of VM guests instantiated on the VM host, the method comprising:
detecting a plug event that the USB device is plugged into the computer system by the VM host;
loading a backend driver in association with the USB device by the VM host;
selecting a target VM guest from among the plurality of VM guests according to a user selection from a user interface; and
assigning the USB device to the target VM guest.

2. The method of claim 1, wherein the step of assigning the USB device to the target VM guest further comprises:
loading a frontend driver in association with the USB device by the target VM guest;
establishing a commutation connection between the backend driver and the frontend driver; and
allocating control of the USB device to the target VM guest via the communication connection.

3. The method of claim 2, further comprising:
detecting an unplug event that the USB device is unplugged from the computer system by the VM host; and
revoking the control of the USB device from the target VM guest.

4. The method of claim 3, wherein the step of revoking the control of the USB device from the VM guest comprises:
destroying the communication connection between the backend driver and the frontend driver; and
unloading the frontend driver in the target VM guest.

5. The method of claim 1, wherein the step of loading the backend driver in association with the USB device by the VM host comprises:
obtaining device identifier information of the USB device; and
determining the backend driver according to the device identifier information.

6. The method of claim 5, further comprising:
transmitting the device identifier information to the target VM guest; and
determining the frontend driver according to the device identifier information by the VM guest.

7. The method of claim 5, wherein the device identifier information comprises a vender ID and a device ID of the USB device.

8. A computer system comprising:
a virtual machine (VM) host;
a plurality of VM guests instantiated on the VM host;
wherein the VM host is adapted to detect a plug event that a USB device is plugged into the computer system, load a backend driver in association with the USB device, select a target VM guest from among the plurality of VM guests according to a user selection from a user interface, and assign the USB device to the target VM guest.

9. The computer system of claim 8, wherein the target VM guest is adapted to load a frontend driver in association with the USB device and the VM host is adapted to establish a communication connection between the backend driver and the frontend driver and allocate control of the USB device to the VM guest via the communication connection.

10. The computer system of claim 9, wherein the VM host is further adapted to detect an unplug event that the USB device is unplugged from the computer system and revoke the control of the USB device from the target VM guest.

11. The computer system of claim 10, wherein the VM host is adapted to destroy the communication connection between the backend driver and the frontend driver, and the target VM guest is adapted to unload the frontend driver after the unplug event is detected.

12. The computer system of claim 8, wherein the VM host is adapted to obtain device identifier information of the USB device and determine the backend driver according to the device identifier information.

13. The computer system of claim 12, wherein the VM host is adapted to transmit the device identifier information to the target VM guest and the VM guest is adapted to determine the frontend driver according to the device identifier information.

14. The computer system of claim 12, wherein the device identifier information comprises a vender ID and a device ID of the USB device.

15. A method for configuring a universal serial bus (USB) device in a computer system, the computer system having a virtual machine (VM) host and a plurality of VM guests instantiated on the VM host, the method comprising:
determining a first VM guest from among the plurality of VM guests, which currently has control of the USB device;
selecting a second VM guest from among the plurality of VM guests according to a user selection from a user interface;
revoking the control of the USB device from the first VM guest; and
allocating the control of the USB device to the second VM guest.

16. The method of claim 15, wherein the step of revoking the control of the USB device from the first VM guest comprises:
destroying a first communication connection between a backend driver associated with the USB device in the VM host and a first frontend driver associated with the USB device in the first VM guest; and
unloading the frontend driver in the first VM guest.

17. The method of claim 15, wherein the step of allocating the control of the USB device to the second VM guest comprises:
loading a second frontend driver associated with the USB device in the second VM guest;
establishing a second communication connection between a backend driver associated with the USB device in the VM host and the second frontend driver in the second VM guest.

18. The method of claim 17, further comprising
transmitting device identifier information of the USB device to the second VM guest; and
determining the second frontend driver according to the device identifier information.

19. The method of claim 17, wherein the device identifier information comprises a vender ID and a device ID of the USB device.
